(19) United States
(12) Patent Application Publication
(10) Pub. No.: US 2026/0370511 A1
(43) Pub. Date: Nov. 19, 2026

(54) DEVICE CONTROL METHOD AND APPARATUS, ELECTRONIC DEVICE, AND COMPUTER-READABLE STORAGE MEDIUM

(71) Applicant: SHENZHEN TCL NEW TECHNOLOGY CO., LTD., Shenzhen, Guangdong (CN)

(72) Inventors: Jingling YUAN, Shenzhen, Guangdong (CN); Qingzhong ZENG, Shenzhen, Guangdong (CN)

(73) Assignee: SHENZHEN TCL NEW TECHNOLOGY CO., LTD., Shenzhen, Guangdong (CN)

(21) Appl. No.: 19/155,254

(22) PCT Filed: Jan. 10, 2024
(86) PCT No.: PCT/CN2024/071642

§ 371 Date: Aug. 10, 2025

(30) Foreign Application Priority Data
Feb. 10, 2023 (CN) 202310125161.2

(51) Int. Cl. H04L 12/28; H04N 21/422; H04W 4/80

(52) U.S. Cl. CPC H04L 12/282; H04W 4/80; H04N 21/42203

(57) ABSTRACT

A device control method includes establishing a Generic Attribute Profile (GATT) connection with a peer device and, based on the GATT connection, establishing an audio transmission link with the peer device, via the GATT connection, establishing a connection of a voice service corresponding to a voice service identifier broadcasted by the peer device, based on the voice service, receiving, by the audio transmission link, audio control information transmitted by the peer device, and executing a control operation corresponding to the audio control information.

This application claims priority to Chinese Patent Applications No. 202310125161.2, filed on Feb. 10, 2023 and entitled “DEVICE CONTROL METHOD AND APPARATUS, ELECTRONIC DEVICE, AND COMPUTER-READABLE STORAGE MEDIUM”. The entire disclosures of the above application are incorporated herein by reference.

### TECHNICAL FIELD

The embodiments of the present application relate to the field of computer technology, and more specifically, to a device control method and apparatus, an electronic device, and a computer-readable storage medium.

### BACKGROUND TECHNOLOGY

With the widespread adoption and development of smart devices, audio control of smart devices using voice has become possible, for example, controlling a smart device's audio via a Bluetooth headset.

### Technical Problem

However, traditional Bluetooth-connected headsets transmit audio using Advanced Audio Distribution Profile (A2DP), and voice transmission requires Hands-Free Profile (HFP), which results in high power consumption.

With the increasing popularity and diversification of smart devices, such as in scenarios involving interconnected smart home systems, there is a growing need for lower-power audio transmission solutions.

### SUMMARY OF INVENTION

The embodiments of the present application provide a device control method and apparatus, an electronic device, and a computer-readable storage medium, which can reduce power consumption of audio transmission.

An embodiment of the present application provides a device control method, applied to a current device, comprising:

Establishing a Generic Attribute Profile (GATT) connection with a peer device, and based on the GATT connection, establishing an audio transmission link with the peer device.

Acquiring a voice service identifier broadcasted by the peer device, and establishing, via the GATT connection, a connection to a voice service corresponding to the voice service identifier.

Receiving, based on the voice service, an audio control information transmitted by the peer device through the audio transmission link.

Executing a control operation corresponding to the audio control information.

Accordingly, an embodiment of the present application further provides a device control apparatus, applied to a current device, comprising:

An attribute service connection module configured to establish a Generic Attribute Profile (GATT) connection with a peer device and, based on the GATT connection, establish an audio transmission link with the peer device.

A voice service connection module configured to acquire a voice service identifier broadcasted by the peer device and establish, via the GATT connection, a connection to a voice service corresponding to the voice service identifier.

An audio transmission module configured to receive, based on the voice service, an audio control information transmitted by the peer device through the audio transmission link.

An operation execution module configured to execute a control operation corresponding to the audio control information.

Optionally, in some embodiments of the present application, the peer devices include at least two devices. The voice service connection module comprises:

A voice service connection unit configured to establish, via the Generic Attribute Profile (GATT) connections established with each of the peer devices, respective connections to voice services corresponding to the voice service identifiers broadcasted by the peer devices.

The operation execution module comprises:

A selection unit configured to select a target audio control information from the audio control information corresponding to each of the peer devices.

An execution unit configured to execute the control operation corresponding to the target audio control information.

In some embodiments of the present application, the selection unit comprises:

A parsing subunit, configured to parse each audio control information to obtain an audio control instruction and a peer device status information.

A selection subunit, configured to select a target audio control instruction from the audio control instructions based on the peer device status information.

The execution unit comprises:

An execution subunit configured to execute the control operation corresponding to the target audio control instruction.

In some embodiments of the present application, the peer device status information includes activation status information, and the selection subunit is further configured to:

If the activation status information of at least two peer devices indicates that the corresponding peer devices are in an active state, acquire the signal strength values of the audio transmission links corresponding to the at least two peer devices.

Determine the peer device corresponding to the maximum signal strength value among the at least two signal strength values as the target peer device.

Determine the audio control instruction corresponding to the target peer device as the target audio control instruction.

In some embodiments of the present application, the peer devices include a remote control and a headset, and the selection subunit is further configured to:

If the activation status information of the remote control and the headset indicates that both the remote control and the headset are in an active state, acquire in-ear status information of the headset.

If the in-ear status information indicates that the headset is in an in-ear state, acquire a first signal strength value of the remote control and a second signal strength value of the headset.

If the first signal strength value is greater than the second signal strength value, determine the remote control as the target peer device.

If the first signal strength value is less than the second signal strength value, determine the headset as the target peer device.

If the first signal strength value is equal to the second signal strength value, randomly select one of the remote control and the headset as the target peer device.

In some embodiments of the present application, the audio transmission module comprises:

A strength value determination unit configured to determine a target signal transmission power value according to a desired signal reception strength value of the current device.

A strength value transmission unit configured to send the target signal transmission power value to the peer device.

An audio reception unit, configured to receive, based on the voice service, the audio control information transmitted by the peer device through the audio transmission link based on the target signal transmission power value.

In some embodiments of the present application, the apparatus further comprises a transmission module, wherein the transmission module comprises:

An acquisition unit configured to acquire audio information to be broadcast, the audio information to be broadcast being generated by an application running on the peer device in response to a user operation, or generated after receiving the user's audio via a microphone.

An audio transmission unit configured to, for each peer device, transmit the audio information to be broadcast to the peer device via the audio transmission link established with the peer device, based on the connection to the voice service of the peer device.

In a third aspect, the embodiments of the present application further provide an electronic device, comprising a memory, a processor, and a computer program stored in the memory and executable on the processor, wherein the computer program, when executed by the processor, performs the steps of the above-described device control method.

In a fourth aspect, the embodiments of the present application further provide a computer-readable storage medium, on which a computer program is stored, wherein the computer program, when executed by a processor, performs the steps of the above-described device control method.

In a fifth aspect, the embodiments of the present application further provide a computer program product or computer program, which comprises computer instructions stored on a computer-readable storage medium. When a processor of a computing device reads and executes the computer instructions from the computer-readable storage medium, the computing device performs the method provided in various optional implementations described in the embodiments of the present application.

### Beneficial Effects

In the embodiments of the present application, a Generic Attribute Profile (GATT) connection is established with a peer device, and based on this connection, an audio transmission link is established with the peer device. Upon acquiring a voice service identifier broadcasted by the peer device, a connection to the corresponding voice service is established via the GATT connection. Based on the voice service, audio control information transmitted by the peer device is received through the audio transmission link, and a control operation corresponding to the audio control information is executed. By establishing the GATT connection with the peer device and, based on it, setting up the audio transmission link, a low-power audio transmission link can be achieved. After connecting to the voice service of the peer device, low-power audio data transmission can be realized based on the voice service and through this low-power link. When the current device receives and responds to the audio control information sent by the peer device, it can perform the corresponding operation, thereby enabling audio-based control of the device.

### BRIEF DESCRIPTION OF THE DRAWINGS

In order to more clearly illustrate technical solutions in embodiments of the present application, accompanying drawings required for describing the embodiments are briefly introduced below. Apparently, the drawings described below are only some embodiments of the present application. For those skilled in the art, other drawings can be obtained based on these drawings without creative efforts.

FIG. 1 is a schematic diagram of a device control method scenario provided in an embodiment of the present application.

FIG. 2 is a flow diagram illustrating a device control method provided in an embodiment of the present application.

FIG. 3 is a flow diagram illustrating audio transmission between a television and a headset as provided in an embodiment of the present application.

FIG. 4 is a flow diagram illustrating voice transmission using Google Voice Service connected to a Bluetooth headset as provided in an embodiment of the present application.

FIG. 5 is a flow diagram illustrating a multi-device voice control strategy as provided in an embodiment of the present application.

FIG. 6 is a structural schematic diagram of a device control apparatus provided in an embodiment of the present application.

FIG. 7 is a structural schematic diagram of the electronic device provided in an embodiment of the present application.

### DETAILED DESCRIPTION OF THE EMBODIMENTS

The technical solutions in the embodiments of the present application will now be clearly and fully described with reference to the accompanying drawings. It is evident that the described embodiments are only part of the embodiments of the present application, and not all embodiments. All other embodiments obtained by those skilled in the art based on the embodiments of the present application without creative efforts shall fall within the scope of protection of the present application.

The embodiments of the present application provide a device control method, apparatus, electronic device, and computer-readable storage medium. Specifically, the embodiments of the present application provide a device control apparatus applicable to electronic devices, wherein the electronic device includes a terminal. The terminal includes, but is not limited to, devices such as computers, tablet PCs, speakers, Bluetooth speakers, mobile phones, televisions, smart refrigerators, and smart air conditioners.

Referring to FIG. 1, taking a television as an example for executing the device control method, the specific execution process is as follows:

A television 10 establishes a Generic Attribute Profile (GATT) connection with a peer device 11, and based on this connection, establishes an audio transmission link with the peer device 11. Upon acquiring a voice service identifier broadcasted by the peer device 11, the television 10 establishes, via the GATT connection, a connection to the voice service corresponding to the voice service identifier within the peer device 11. Based on this voice service, the television 10 receives audio control information transmitted by the peer device 11 through the audio transmission link, and then executes the control operation corresponding to the audio control information.

It can be understood that, in the embodiments of the present application, the peer device 11 may include devices such as True Wireless Stereo (TWS) earbuds, over-ear Bluetooth headsets, hearing aids, Bluetooth voice remote controls, and the like.

In the embodiments of the present application, a Generic Attribute Profile (GATT) connection is established with the peer device, and based on this connection, an audio transmission link is established with the peer device. Upon acquiring a voice service identifier broadcasted by the peer device, a connection to the corresponding voice service is established via the GATT connection. Based on the voice service, the audio control information transmitted by the peer device is received through the audio transmission link, and a control operation corresponding to the audio control information is executed. By establishing the GATT connection with the peer device and, based on it, establishing the audio transmission link, a low-power audio transmission link is achieved. After connecting to the voice service of the peer device, low-power audio data transmission can be realized using the voice service over this link. When the current device receives and responds to the audio control information from the peer device, it can execute the corresponding action, thereby enabling audio-based device control.

The following provides a detailed description. It should be noted that the order of the following embodiments is not intended to limit the priority of the embodiments.

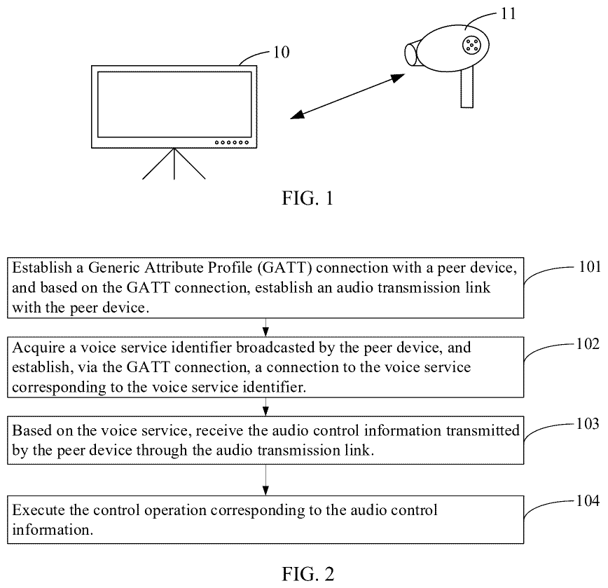

Please refer to FIG. 2, which is a flow diagram illustrating the device control method provided in an embodiment of the present application. The specific process of the device control method is as follows:
101. Establish a Generic Attribute Profile (GATT) connection with a peer device, and based on the GATT connection, establish an audio transmission link with the peer device.

It can be understood that, in the embodiments of the present application, the peer device is a device with voice interaction capabilities, including but not limited to True Wireless Stereo (TWS) earbuds, over-ear Bluetooth headsets, hearing aids, and Bluetooth voice remote controls.

It should be noted that the Generic Attribute Profile (GATT) defines a service framework using the Attribute Protocol (ATT). This framework specifies the procedures and formats of services and their characteristics. The defined procedures include discovery, read, write, notification, and indication of characteristics, as well as configuration of characteristic broadcasting. The GATT protocol is used by the application layer and other protocols to enable communication between a client and a server.

It can be understood that, in the embodiments of the present application, the audio transmission link is a link responsible for audio data transmission, such as a Connected Isochronous Stream (CIS) link, which transmits audio data through the delivery of ISO data packets.

It can also be understood that, after establishing a GATT connection and, based on it, establishing an audio transmission link with the peer device, a Bluetooth Low Energy (BLE) audio transmission link is effectively established.

Accordingly, during the actual operation process, before establishing a Generic Attribute Profile (GATT) connection with the peer device, it is necessary to first establish a physical link connection (e.g., Asynchronous Connectionless Link) and a logical link connection with the peer device. The physical and logical links are responsible for Logical Link Control and Adaptation Protocol (L2CAP) and data transmission. Specifically, the physical link connection includes the Asynchronous Connectionless (ACL) link, which is established via the Host Controller Interface (HCI) of the Bluetooth chip. Correspondingly, the Service Discovery Protocol (SDP) is used to obtain the supported protocol information of the peer device and to establish a logical link connection (L2CAP) with the peer device.

Subsequently, communication between the Bluetooth profiles and services is achieved via the Attribute Protocol (ATT). Based on the ATT, a Generic Attribute Profile (GATT) connection is established with the peer device.
102. Acquire a voice service identifier broadcasted by the peer device, and establish, via the GATT connection, a connection to the voice service corresponding to the voice service identifier.

It should be noted that the voice service identifier is an identifier corresponding to a voice service. This identifier may be a code, such as a Universally Unique Identifier (UUID). Each voice service corresponds to a unique identifier, which can be used to retrieve the corresponding service from the list of services supported by the peer device.

For example, in the embodiments of the present application, the voice service identifier may be represented as: ATV Voice Service [ATVV_SERVICE UUID: AB5E0001-5A21-4F05-BC7D-AF01F617B664].

It can be understood that by establishing a connection with the voice service of the peer device, audio transmission between the current device and the peer device can be carried out based on the voice service.
103. Based on the voice service, receive the audio control information transmitted by the peer device through the audio transmission link.

It can be understood that when voice service support exists between devices, audio data transmission can be carried out through the corresponding audio transmission link, thereby enabling the transmission of voice-related data.

It can also be understood that the audio control information refers to information containing control attributes or control commands, such as audio data corresponding to a control phrase. By receiving the audio control information sent from the peer device, the current device can be controlled accordingly, thereby realizing audio-based device control.

For example, after the current device has successfully paired and connected with the peer device, the current device sends a command to the peer device to obtain the voice input capabilities of the peer device. This command is sent via the ATVV_CHAR_TX characteristic. Upon receiving the command, the peer device responds with its voice input capability information via an ATVV_CHAR_CTL notification.

Correspondingly, as an audio input device, the peer device is equipped with an internal microphone. When the peer device is controlled using a touch button, voice search is initiated, and the peer device sends a key event (HID: page 0x0C, key value: 0x221) to the current device.

At the same time, the peer device also sends a data packet (value: 0x08) to the current device via an ATVV_CHAR_CTL notification. When the current device is ready to start receiving data from the peer device, it sends the Mic_open( ) command through the ATVV_CHAR TX characteristic. Audio data transmission over the audio transmission link can then begin. For instance, after receiving an ATVV_CHAR_CTL command (e.g., value: 0x04), the peer device starts transmitting; the transmission ends when an ATVV_CHAR_CTL notification with value 0x00 is received.

Accordingly, when the peer device stops voice input, it sends a timeout message to the current device. Upon receiving the timeout message, the current device sends a MIC CLOSE command to the peer device. The peer device does not respond to this command thereafter.

It should be noted that during the audio transmission process, AUDIO_SYNC messages are periodically sent within a certain period of time to maintain synchronization between the current device and the peer device.
104. Execute the control operation corresponding to the audio control information.

It can be understood that, by executing the control operation corresponding to the audio control information, remote voice control of the current device via the peer device is achieved.

Accordingly, in the embodiments of the present application, after receiving the audio control information from the peer device, the current device may decode the audio data using the Low Complexity Communication Codec (LC3), which is the mandatory codec for Bluetooth Low Energy Audio. This improves audio quality even under low bitrate transmission. Similarly, the peer device may encode the audio data using the LC3 codec format before transmitting it.

It can be understood that the embodiments of the present application establish a Generic Attribute Profile (GATT) connection with a peer device and, based on that connection, establish an audio transmission link with the peer device. Upon acquiring a voice service identifier broadcasted by the peer device, a connection to the corresponding voice service is established via the GATT connection. Based on this voice service, the current device receives audio control information transmitted by the peer device through the audio transmission link and executes the corresponding control operation. By establishing the GATT connection and subsequently the audio transmission link with the peer device, a low-power audio transmission link is established. After connecting to the peer device's voice service, low-power transmission of audio data can be realized through this link. When the current device receives and responds to the audio control information sent by the peer device, it can perform the corresponding operation, thus achieving audio-based control of the device.

Optionally, the current device may establish separate Generic Attribute Profile (GATT) connections with multiple peer devices and, based on each GATT connection, establish a connection with the voice service of the corresponding peer device. That is, in some embodiments of the present application, the peer devices include at least two devices, and the step of “establishing a connection to the voice service corresponding to the voice service identifier via the GATT connection” comprises:

Establishing, via the GATT connections established with each of the peer devices, respective connections to the voice services corresponding to the voice service identifiers broadcasted by the peer devices.

It can be understood that by separately establishing GATT connections with multiple peer devices and establishing connections with the voice services of each peer device based on their respective GATT connections, the current device can build low-power audio transmission links with each peer device. This enables the current device to be simultaneously connected with multiple other devices, each of which can serve as an input device to transmit audio data to the current device.

Similarly, after the current device has established connections with the voice services of multiple other devices, the current device may also serve as an input source for those other devices—that is, the audio data generated by the current device can be shared with multiple peer devices. Optionally, in some embodiments of the present application, after the step of “establishing, via the Generic Attribute Profile (GATT) connections established with each of the peer devices, respective connections to the voice services corresponding to the voice service identifiers broadcasted by the peer devices,” the method further comprises:
Acquiring audio information to be broadcast, wherein the audio information to be broadcast is generated by an application running on the peer device in response to a user operation, or generated after receiving the user's audio via a microphone.

For each peer device, transmitting the audio information to be broadcast to the peer device via the audio transmission link established with that peer device, based on the connection to its voice service.

The other peer devices, serving as receiving devices of the current device, can conveniently receive audio commands sent simultaneously from the current device to each of them.

The design of performing audio transmission based on a low-power audio transmission link and voice service supports coordinated control among multiple smart home devices, and the low-power transmission helps to reduce energy consumption and device operating costs. At the same time, in the embodiments of the present application, the use of the LC3 codec format for encoding and decoding audio data improves audio quality under low bitrate transmission.

It can be understood that, compared to the related technologies where audio is transmitted via the Advanced Audio Distribution Profile (A2DP) and voice requires multiple processes such as the Hands-Free Profile (HFP), the embodiments of this application simplify the interaction flow in the audio transmission process by using the Generic Attribute Profile (GATT) and the link established based on it, thereby achieving reduced transmission power consumption.

Optionally, in the embodiments of the present application, when the outputs of multiple peer devices serve as inputs to the current device, there may be cases where multiple audio data inputs are received simultaneously. To ensure the effectiveness and accuracy of device audio control, it is also possible to select valid target audio control information from the multiple pieces of audio control information received from the various devices, and control the current device based on the selected target information. That is, optionally, in some embodiments of the present application, the step “executing the control operation corresponding to the audio control information” comprises:

Selecting target audio control information from the audio control information corresponding to each of the peer devices.

Executing a control operation corresponding to the target audio control information.

It can be understood that the selection of target audio control information can improve the effectiveness and accuracy of device audio control. Therefore, the selection of the target audio control information directly determines the quality of the audio control for the device.

Optionally, in the embodiments of the present application, the target audio control information can be selected based on the device status of each peer device. That is, optionally, in some embodiments of the present application, the step of “selecting target audio control information from the audio control information corresponding to each of the peer devices” comprises:

Parsing each piece of audio control information to obtain an audio control instruction and the status information of the corresponding peer device.

Selecting a target audio control instruction from the audio control instructions based on the status information of the peer devices.

It should be noted that the audio control instruction is used to instruct the current device to perform a corresponding action, such as playing a video, playing audio, turning off the video, powering off, and other commands.

It should also be noted that the peer device status information is used to describe the state of the peer device, such as activation status, in-ear status, etc.

It can be understood that the peer device status information is generated after being detected by the peer device. By encoding the peer device status information into the audio control information, it can be transmitted to the current device along with the audio control information. As a result, after the current device receives the audio control information, it can parse and obtain the corresponding peer device status information for each piece of audio control information.

By filtering audio control instructions based on the peer device status information, the selected audio control instructions can meet the state requirements of the peer devices. For example, when the peer device status information indicates that the peer device is in an active state (i.e., normal communication state), the audio control instruction corresponding to that peer device is selected as the target audio control instruction.

Accordingly, after parsing the audio control instruction from the audio control information and selecting the target audio control instruction from the available instructions, the current device may execute the control operation corresponding to the target instruction. That is, optionally, in some embodiments of the present application, the step “executing the control operation corresponding to the target audio control information” comprises:

Executing the control operation corresponding to the target audio control instruction.

It can be understood that, by executing the corresponding control operation, the current device achieves audio control via the peer device.

It should be noted that if multiple devices are in an active state, it is necessary to select a target peer device from among those active devices, and then determine the audio control instruction corresponding to the target peer device as the target audio control instruction.

Since signal strength affects the quality of signal transmission, in the embodiments of the present application, when multiple devices are in an active state, the target audio control instruction can be selected from the corresponding audio control instructions based on the signal strength of the audio transmission links established between each device and the current device. That is, optionally, in some embodiments of the present application, the peer device status information includes activation status information, and the step “selecting the target audio control instruction from the audio control instructions based on the peer device status information” comprises:

If the activation status information of at least two peer devices indicates that the corresponding peer devices are in an active state, acquiring the signal strength values of the audio transmission links corresponding to the at least two peer devices.

Determining the peer device corresponding to the maximum signal strength value among the at least two signal strength values as the target peer device.

Determining the audio control instruction corresponding to the target peer device as the target audio control instruction.

It should be noted that the signal strength value of the audio transmission link reflects the signal quality of the link. For example, in the case of a link established using Bluetooth technology, the Bluetooth signal strength indicates the quality of signal transmission. The signal strength value affects the transmission quality, which in turn impacts the quality of the received audio control instructions. A link with a higher signal strength value generally receives clearer audio, resulting in more accurate voice recognition. Therefore, the peer device corresponding to the higher signal strength value can be selected as the target peer device to ensure that the selected target audio control instruction is more effective and accurate.

Accordingly, in the embodiments of the present application, specific device status information may be introduced for particular devices to indicate whether a device is in an available state, thereby reflecting the effectiveness of the audio information transmitted from that device. For example, for a headset device, the in-ear status information can be used to determine whether the headset is being worn, and consequently, whether the audio information transmitted through the headset is valid and clear. That is, optionally, in some embodiments of the present application, where the peer devices include a remote control and a headset, the step “if the activation status information of at least two peer devices indicates that the corresponding peer devices are in an active state, acquire the signal strength values of the audio transmission links corresponding to the at least two peer devices” comprises:

If the activation status information of both the remote control and the headset indicates that they are in an active state, then acquire the in-ear status information of the headset.

If the in-ear status information indicates that the headset is in an in-ear state, then acquire the first signal strength value of the remote control and the second signal strength value of the headset.

Determining the peer device corresponding to the highest signal strength value among the at least two signal strength values as the target peer device comprises:

If the first signal strength value is greater than the second signal strength value, then the remote control is selected as the target peer device.

If the first signal strength value is less than the second signal strength value, then the headset is selected as the target peer device.

If the first signal strength value is equal to the second signal strength value, then one of the remote control and the headset is randomly selected as the target peer device.

The term remote control refers to a remote control capable of voice input, such as a Bluetooth voice remote control.

It can be understood that when a device is in an active state, it does not necessarily mean that the device is currently in use or in a state the user intends to use. For example, in the case of a headset, even if the headset is active, if it is not being worn or not in an in-ear state, it indicates that the user is not actually intending to use the headset for voice input. Therefore, it is necessary to perform device-specific state checks for such devices. Similarly, for a remote control, whether it is in a handheld state can be used to determine whether the audio data it transmits is actually generated by a user operation.

It should be noted that the in-ear status information reflects whether the headset is being worn, and this status can be obtained through in-ear detection. Generally, when a headset is in the in-ear state, it indicates that the user is actively using the headset, and therefore, the headset is considered to have a higher priority. Accordingly, when both the remote control and the headset are in an active state, and the headset is also in the in-ear state, additional criteria may be introduced to assist in device selection-for example, using the signal strength of the audio transmission links established with each device to determine the target peer device. Likewise, a link with higher signal strength can ensure better audio quality during transmission. Therefore, selecting the target peer device based on signal strength helps ensure the effectiveness and accuracy of the target audio control instruction selected from the corresponding peer device.

It can be understood that, for the current device, when it receives audio data from a peer device, it functions as a receiver. For a receiver, optimal performance is achieved only when the signal strength falls within a certain moderate range, not too strong and not too weak. For example, the signal should not be so strong as to cause saturation, nor so weak as to result in decoding errors.

Therefore, in the embodiments of the present application, the transmission power of the peer device can be adjusted according to the desired signal strength for the current device during reception, ensuring that the current device receives audio data at an optimal and expected signal strength. That is, optionally, in some embodiments of the present application, the step “receiving the audio control information transmitted by the peer device through the audio transmission link based on the voice service” comprises:

Determining a target transmission power value based on the desired signal reception strength of the current device.

Sending the target transmission power value to the peer device.

Receiving, based on the voice service, the audio control information transmitted by the peer device through the audio transmission link using the target transmission power value.

In the embodiments of the present application, the desired signal reception strength value refers to the optimal signal strength for the current device to receive signals. This optimal value can be pre-configured at the factory or determined based on the current device's hardware specifications and parameters.

By determining the transmission power of the peer device based on the desired signal reception strength, the peer device can transmit signals in a manner that allows the current device to remain in its optimal or near-optimal reception state, thereby improving the stability and accuracy of audio data transmission.

It can be understood that the design of performing audio transmission based on a low-power audio transmission link and voice service is well-suited for multi-smart home device coordination scenarios. The low-power transmission helps reduce energy consumption and device operation costs, while the use of the LC3 codec format for encoding and decoding improves audio quality even under low-bitrate transmission.

Accordingly, in scenarios involving multi-device input coordination, it is also possible to select a target peer device from multiple peer devices based on each device's activation status, in-ear status, and the signal strength of the corresponding link. This enables the selection of a target audio control instruction and provides a solution for selecting a master control device in environments with multiple input devices.

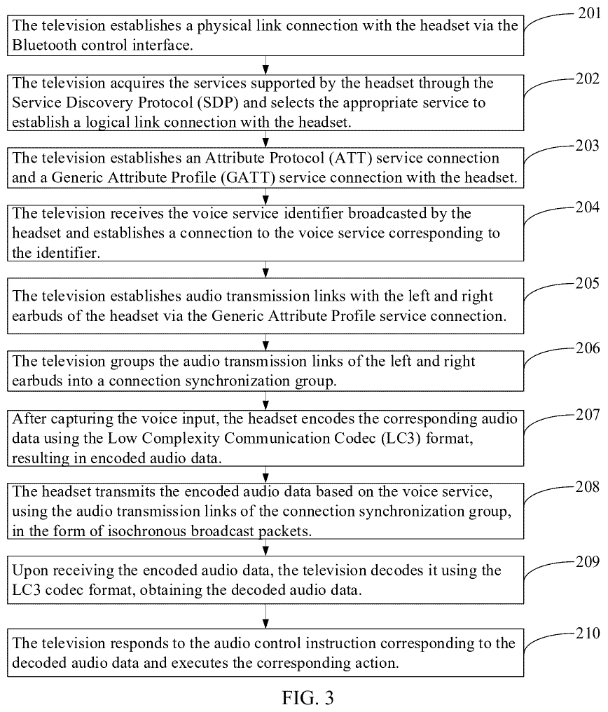

Please refer to FIG. 3, which is a flow diagram illustrating the audio transmission process between a television and a headset as provided in an embodiment of the present application. The specific steps of this audio transmission process include:
201. The television establishes a physical link connection with the headset via the Bluetooth control interface.

It should be noted that the control interface includes interfaces provided by the Bluetooth chip, such as the HCl (Host Controller Interface), and the physical link includes an ACL (Asynchronous Connectionless Link).
202. The television acquires the services supported by the headset through the Service Discovery Protocol (SDP) and selects the appropriate service to establish a logical link connection with the headset.
203. The television establishes an Attribute Protocol (ATT) service connection and a Generic Attribute Profile (GATT) service connection with the headset.

It should be noted that the Attribute Protocol service corresponds to the ATT, and the Generic Attribute Profile service corresponds to the GATT.
204. The television receives the voice service identifier broadcasted by the headset and establishes a connection to the voice service corresponding to the identifier.

In the embodiment of the present application, the voice service identifier may be represented as: ATV Voice Service [ATVV_SERVICE UUID AB5E0001-5A21-4F05-BC7D-AF01F617B664].
205. The television establishes audio transmission links with the left and right earbuds of the headset via the Generic Attribute Profile service connection.

It should be noted that the CIS (Connected Isochronous Stream) audio transmission links transmit audio data using ISO (Isochronous) data packets.
206. The television groups the audio transmission links of the left and right earbuds into a connection synchronization group.
207. After capturing the voice input, the headset encodes the corresponding audio data using the Low Complexity Communication Codec (LC3 ) format, resulting in encoded audio data.
208. The headset transmits the encoded audio data based on the voice service, using the audio transmission links of the connection synchronization group, in the form of isochronous broadcast packets.
209. Upon receiving the encoded audio data, the television decodes it using the LC3 codec format, obtaining the decoded audio data.
210. The television responds to the audio control instruction corresponding to the decoded audio data and executes the corresponding action.

In this process, the audio transmission links between the television and the headset are established via the Generic Attribute Profile (GATT) service, enabling the setup of a Bluetooth Low Energy (BLE) Audio transmission link. Compared with related technologies, where audio transmission between a television and a headset requires the Advanced Audio Distribution Profile (A2DP) and voice transmission involves complex interaction through the Hands-Free Profile (HFP), the embodiment of the present application simplifies the interaction process and reduces power consumption. Furthermore, by using the LC3 codec format, the system achieves improved audio quality even under low-bitrate transmission.

Accordingly, the method of establishing audio transmission links via the Generic Attribute Profile (GATT) service supports multi-device access. For example, devices such as Bluetooth headsets, hearing aids, and Bluetooth voice remote controls can each establish a GATT connection with the television, and corresponding audio transmission links can be set up individually, forming a solution where the television is connected to multiple devices. In this scenario, the television may act as an output device, simultaneously sharing audio with multiple connected devices via their respective audio transmission links. Conversely, the other devices may also send audio data to the television through their respective audio transmission links.

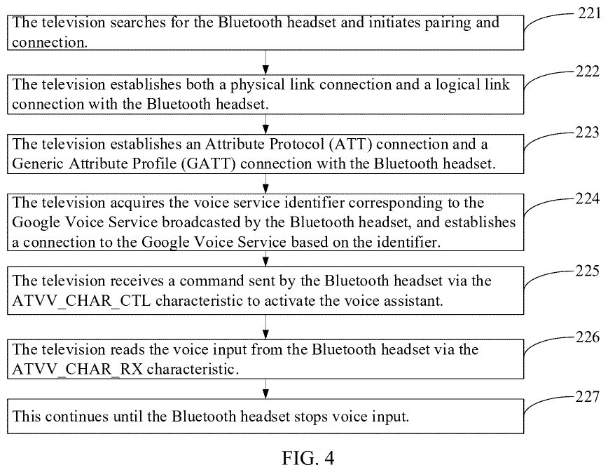

Please refer to FIG. 4, which is a flow diagram illustrating voice transmission using Google Voice Service connected via a Bluetooth headset, as provided in an embodiment of the present application. Specifically:
221. The television searches for the Bluetooth headset and initiates pairing and connection.
222. The television establishes both a physical link connection and a logical link connection with the Bluetooth headset.
223. The television establishes an Attribute Protocol (ATT) connection and a Generic Attribute Profile (GATT) connection with the Bluetooth headset.
224. The television acquires the voice service identifier corresponding to the Google Voice Service broadcasted by the Bluetooth headset, and establishes a connection to the Google Voice Service based on the identifier.
225. The television receives a command sent by the Bluetooth headset via the ATVV CHAR CTL characteristic to activate the voice assistant.
226. The television reads the voice input from the Bluetooth headset via the ATVV CHAR RX characteristic.
227. This continues until the Bluetooth headset stops voice input.

By connecting to the Google Voice Service of the Bluetooth headset, the link established between the television and the Bluetooth headset can be used for audio data transmission.

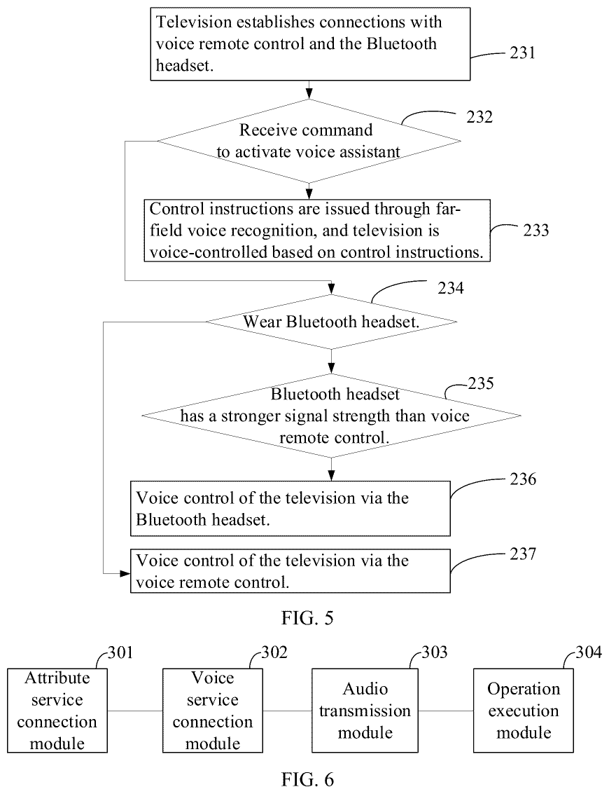

Accordingly, when multiple devices simultaneously send audio data to the television, the television can filter the audio data from these devices based on factors such as activation status, in-ear status, handheld status, or the signal strength of the corresponding transmission links. The television then selects one set of audio data to respond to and performs the corresponding action. As shown in FIG. 5, FIG. 5 is a flow diagram illustrating a multi-device voice control strategy provided in an embodiment of the present application. The multi-device voice control strategy specifically includes:
231. The television establishes connections with the voice remote control and the Bluetooth headset.
232. Determine whether a command to activate the voice assistant is received. If received, proceed to step 234. If not received, proceed to step 233.
233. Control instructions are issued through far-field voice recognition, and the television is voice-controlled based on these control instructions.

Note: Far-field voice recognition refers to audio captured by the television's built-in microphone.
234. Use in-ear detection to determine whether the Bluetooth headset is being worn. If worn, proceed to step 235. If not worn, proceed to step 237.
235. Determine whether the Bluetooth headset's signal strength is stronger than that of the voice remote control. If yes, proceed to step 236.

If not, proceed to step 237.
236. Perform voice control of the television via the Bluetooth headset.
237. Perform voice control of the television via the voice remote control.

In scenarios where the outputs of multiple devices serve as inputs to the television, the device states of these multiple devices can be analyzed to select a single device to control the television. The device state can be evaluated based on the type of device, with the goal of determining whether the device is in an effective usage state-that is, assessing the reliability of the audio data transmitted from the device.

To facilitate better implementation of the device control method described above, the present application further provides a device control apparatus based on the aforementioned method. The meanings of the terms used here are the same as those in the device control method, and the specific implementation details can be referred to in the method embodiments.

Please refer to FIG. 6, which is a structural schematic diagram of the device control apparatus provided in an embodiment of the present application. The device control apparatus may specifically include the following components:
Attribute service connection module 301, configured to establish a Generic Attribute Profile (GATT) connection with a peer device, and based on the GATT connection, establish an audio transmission link with the peer device.
Voice service connection module 302, configured to acquire a voice service identifier broadcasted by the peer device, and establish, via the GATT connection, a connection to the voice service corresponding to the voice service identifier.
Audio transmission module 303, configured to receive, based on the voice service, audio control information transmitted by the peer device through the audio transmission link.
Operation execution module 304, configured to execute the control operation corresponding to the audio control information.

Optionally, in some embodiments of the present application, the peer devices include at least two devices. The voice service connection module 302 comprises:

A voice service connection unit, configured to establish, via the Generic Attribute Profile (GATT) connections established with each of the peer devices, respective connections to the voice services corresponding to the voice service identifiers broadcasted by the peer devices.

The operation execution module 304 comprises:
A selection unit, configured to select target audio control information from the audio control information corresponding to each of the peer devices.
An execution unit, configured to execute the control operation corresponding to the target audio control information.

In some embodiments of the present application, the selection unit further comprises:

A parsing subunit, configured to parse each piece of audio control information to obtain an audio control instruction and the status information of the corresponding peer device.

A selection subunit, configured to select a target audio control instruction from the audio control instructions based on the peer device status information.

The execution unit comprises:
An execution subunit, configured to execute the control operation corresponding to the target audio control instruction.

In some embodiments of the present application, the peer device status information includes activation status information, and the selection subunit is specifically configured to:

If the activation status information of at least two peer devices indicates that the corresponding peer devices are in an active state, acquire the signal strength values of the audio transmission links corresponding to the at least two peer devices.

Determine the peer device corresponding to the maximum signal strength value among the signal strength values as the target peer device.

Determine the audio control instruction corresponding to the target peer device as the target audio control instruction.

In some embodiments of the present application, where the peer devices include a remote control and a headset, the selection subunit is further specifically configured to:
If the activation status information of both the remote control and the headset indicates that they are in an active state, acquire the in-ear status information of the headset.
If the in-ear status information indicates that the headset is in an in-ear state, acquire the first signal strength value of the remote control and the second signal strength value of the headset.
If the first signal strength value is greater than the second signal strength value, determine the remote control as the target peer device.
If the first signal strength value is less than the second signal strength value, determine the headset as the target peer device.
If the first and second signal strength values are equal, randomly select one of the remote control and the headset as the target peer device.

In some embodiments of the present application, the audio transmission module 303 comprises:
A strength value determination unit, configured to determine a target signal transmission power value based on the desired signal reception strength of the current device.
A strength value transmission unit, configured to send the target signal transmission power value to the peer device.
An audio reception unit, configured to receive, based on the voice service, the audio control information transmitted by the peer device through the audio transmission link using the target signal transmission power value.

In some embodiments of the present application, the apparatus further comprises a transmission module, which includes:

An acquisition unit, configured to acquire audio information to be broadcast, wherein the audio information to be broadcast is generated by an application running on the peer device in response to a user operation, or generated after receiving the user's audio via a microphone.

An audio transmission unit, configured to, for each peer device, transmit the audio information to be broadcast to the peer device via the audio transmission link established with that peer device, based on the connection to its voice service.

In the embodiments of the present application, the Attribute Service Connection Module 301 establishes a Generic Attribute Profile (GATT) connection with a peer device and, based on the GATT connection, establishes an audio transmission link with the peer device. Next, the Voice Service Connection Module 302 acquires a voice service identifier broadcasted by the peer device and, via the GATT connection, establishes a connection to the voice service corresponding to the identifier. Subsequently, the Audio Transmission Module 303 receives, based on the voice service, the audio control information transmitted by the peer device through the audio transmission link. Then, the Operation Execution Module 304 executes the control operation corresponding to the received audio control information.

By establishing the GATT connection and, based on it, the audio transmission link with the peer device, a low-power audio transmission link is achieved. After connecting to the voice service of the peer device, audio data can be transmitted over this link in a low-power manner based on the voice service. When the current device receives and responds to the audio control information sent by the peer device, it can perform the corresponding action, thereby achieving audio-based control of the device.

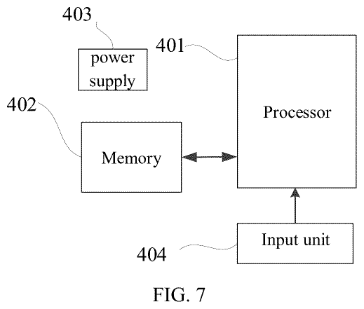

In addition, the present application also provides an electronic device, as illustrated in FIG. 7, which shows a schematic structural diagram of the electronic device described herein. Specifically:

The electronic device may include a processor 401 with one or more processing cores, a memory 402 comprising one or more computer-readable storage media, a power supply 403, an input unit 404, and other components. It should be understood by those skilled in the art that the structure of the electronic device shown in FIG. 7 is not intended to be limiting. The device may include more or fewer components than illustrated, may combine certain components, or arrange them differently.

The processor 401 serves as the control center of the electronic device. It connects various parts of the device via multiple interfaces and circuits, and by running or executing software programs and/or modules stored in the memory 402, and calling data stored in the memory 402, it performs various functions and data processing tasks of the electronic device, thus enabling centralized control of the device. Optionally, the processor 401 may include one or more processing cores. Preferably, the processor 401 may integrate both an application processor and a modem processor, where the application processor mainly handles the operating system, user interface, and application programs, while the modem processor primarily handles wireless communications. It is understood that the above-mentioned modem processor may also be implemented separately, and not integrated into processor 401.

The memory 402 may be used to store software programs and modules, which the processor 401 executes to perform various functional applications and data processing tasks. The memory 402 may primarily include a program storage area and a data storage area. The program storage area may store the operating system, and at least one application program required for functionality (such as audio playback, image display, etc.); the data storage area may store data generated during the use of the electronic device. Additionally, the memory 402 may include high-speed random access memory (RAM), and may also include non-volatile memory, such as at least one disk storage device, flash memory device, or other non-volatile solid-state memory devices. Accordingly, the memory 402 may further include a memory controller to provide access to the memory 402 by the processor 401.

The electronic device also includes a power supply 403, which provides power to various components. Preferably, the power supply 403 is logically connected to the processor 401 via a power management system, thereby enabling management of charging, discharging, and power consumption through the power management system. The power supply 403 may include one or more DC or AC power sources, rechargeable systems, power failure detection circuits, power converters or inverters, power status indicators, and other components.

The electronic device may also include an input unit 404, which is used to receive input such as numbers or characters, and to generate input signals related to user settings and function controls through components such as a keyboard, mouse, joystick, optical sensor, or trackball.

Although not shown, the electronic device may further include a display unit and other components, which are not elaborated here. Specifically, in the present embodiment, the processor 401 of the electronic device executes instructions to load the executable files corresponding to one or more application processes into memory 402, and runs the application(s) stored in the memory 402, thereby performing the steps of any of the device control methods provided in the embodiments of the present application.

The specific implementations of the above operations can be referred to in the previous embodiments and are not repeated here.

In the embodiments of the present application, a Generic Attribute Profile (GATT) connection is established with a peer device, and based on this connection, an audio transmission link is created. Upon receiving a voice service identifier broadcasted by the peer device, a connection to the corresponding voice service is established via the GATT connection. Based on this voice service, the current device receives audio control information transmitted by the peer device through the audio transmission link and executes the control operation corresponding to the audio control information. Once the GATT connection and the associated audio transmission link are established, a low-power audio transmission link is formed. After the voice service of the peer device is connected, audio data can be transmitted with low power consumption using the voice service over this link. When the current device receives and responds to the audio control information from the peer device, it can perform the corresponding action, thereby achieving audio-based control of the device.

It will be understood by those skilled in the art that some or all of the steps of the methods in the above embodiments can be implemented by computer instructions, or by hardware controlled by such instructions. These instructions can be stored on a computer-readable storage medium and executed by a processor.

To this end, the present application also provides a computer-readable storage medium, on which a computer program is stored. This program can be loaded by a processor to execute the steps of any of the device control methods provided in this application.

The specific implementation of each of the above operations can be referred to in the previous embodiments and will not be repeated here.

The computer-readable storage medium may include, for example: Read-Only Memory (ROM), Random Access Memory (RAM), magnetic disks, optical disks, and the like.

Since the instructions stored on the computer-readable storage medium can execute the steps of any of the device control methods provided in the present application, they can achieve the beneficial effects of such methods, as detailed in the previous embodiments, which are not repeated here.

The above has provided a detailed description of a device control method, device control apparatus, electronic device, and computer-readable storage medium as disclosed in the present application. Specific examples have been used to illustrate the principles and implementation of the present invention. These embodiments are intended to assist in understanding the method and core concepts of the invention. For those skilled in the art, modifications may be made to the specific implementations and application scope based on the teachings of the present invention. Therefore, the content of this specification should not be construed as limiting the scope of the invention.

It should also be noted that in the specific embodiments of this application, any data involved-such as audio control data generated for voice control of smart devices, device model information, and protocols and services related to device connectivity, when applied to actual products or technologies, shall be subject to user permission or consent, and the collection, use, and processing of such data must comply with applicable laws, regulations, and standards of relevant countries or regions.

1. A device control method, applied to a current device, comprising:
establishing a Generic Attribute Profile (GATT) connection with a peer device, and based on the GATT connection, establishing an audio transmission link with the peer device;
acquiring a voice service identifier broadcasted by the peer device, and establishing, via the GATT connection, a connection to a voice service corresponding to the voice service identifier;
receiving, based on the voice service, an audio control information transmitted by the peer device through the audio transmission link; and
executing a control operation corresponding to the audio control information.

2. The method according to claim 1, wherein the peer device comprises at least two devices, and establishing, via the GATT connection, the connection to the voice service corresponding to the voice service identifier comprises:
establishing, via the GATT connection established with each of peer devices, a respective connection to the voice service corresponding to the voice service identifier broadcasted by each of the peer devices.

3. The method according to claim 2, wherein executing the control operation corresponding to the audio control information comprises:
selecting a target audio control information from the audio control information corresponding to each of the peer devices; and
executing the control operation corresponding to the target audio control information.

4. The method according to claim 3, wherein selecting the target audio control information from the audio control information corresponding to each of the peer devices comprises:
parsing each audio control information to obtain audio control instructions and a peer device status information;
selecting a target audio control instruction from the audio control instructions based on the peer device status information.

5. The method according to claim 4, wherein executing the control operation corresponding to the target audio control information comprises:
executing the control operation corresponding to the target audio control instruction.

6. The method according to claim 5, wherein the peer device status information comprises an activation status information, and selecting the target audio control instruction from the audio control instructions based on the peer device status information comprises:
if the activation status information of at least two peer devices indicates that corresponding peer devices are in an active state, acquiring signal strength values of audio transmission links corresponding to the at least two peer devices;
determining the peer device corresponding to a maximum signal strength value among at least two signal strength values as a target peer device;
determining the audio control instructions corresponding to the target peer device as the target audio control instruction.

7. The method according to claim 6, wherein the peer devices comprise a remote control and a headset, and acquiring the signal strength values of the audio transmission links corresponding to the at least two peer devices when the activation status information of the remote control and the headset indicates that both are in an active state comprises:
if the activation status information of the remote control and the headset indicates that both the remote control and the headset are in the active state, acquiring an in-ear status information of the headset; and
if the in-ear status information indicates that the headset is in an in-ear state, acquiring a first signal strength value of the remote control and a second signal strength value of the headset.

8. The method according to claim 7, wherein determining the peer device corresponding to the maximum signal strength value among the at least two signal strength values as the target peer device comprises:
if the first signal strength value is greater than the second signal strength value, determining the remote control as the target peer device;
if the first signal strength value is less than the second signal strength value, determining the headset as the target peer device; and
if the first signal strength value is equal to the second signal strength value, randomly selecting one of the remote control and the headset as the target peer device.

9. The method according to claim 7, wherein if the in-ear status information indicates that the headset is in the in-ear state, acquiring the first signal strength value of the remote control and the second signal strength value of the headset comprises:
acquiring a handheld status information of the remote control; and
if the handheld status information indicates that the remote control is in a handheld state, acquiring the first signal strength value of the remote control and the second signal strength value of the headset.

10. The method according to claim 7, wherein acquiring the in-ear status information of the headset comprises:
performing in-ear detection on the headset to obtain an in-ear detection result; and
generating the in-ear status information based on the in-ear detection result.

11. The method according to claim 1, wherein receiving the audio control information transmitted by the peer device through the audio transmission link based on the voice service comprises:
determining a target signal transmission power value according to a desired signal reception strength value of the current device;
sending the target signal transmission power value to the peer device;
receiving, based on the voice service, the audio control information transmitted by the peer device through the audio transmission link based on the target signal transmission power value.

12. The method according to claim 2, wherein after establishing, via the GATT connections with each of the peer devices, respective connections to the voice services corresponding to the voice service identifiers broadcasted by the peer devices, the method further comprises:
acquiring an audio information to be broadcast, the audio information to be broadcast being generated by an application running on the peer device in response to a user operation, or generated after receiving a user audio via a microphone; and
for each peer device, transmitting the audio information to be broadcast to the peer device via the audio transmission link established with the peer device, based on the connection to the voice service of the peer device.

13. The method according to claim 1, wherein prior to establishing the GATT connection with the peer device, the method further comprises:
establishing a physical link connection and a logical link connection with the peer device;
establishing a communication connection between a Bluetooth specification and services via an Attribute Protocol;
wherein establishing the GATT connection with the peer device comprises:
establishing the GATT connection with the peer device based on the Attribute Protocol.

14. The method according to claim 1, wherein the voice service identifier comprises a universally unique identifier (UUID), and acquiring the voice service identifier broadcasted by the peer device and establishing, via the GATT connection, a connection to the voice service corresponding to the voice service identifier comprises:
acquiring the UUID broadcasted by the peer device;
establishing, via the GATT connection, the connection to the voice service corresponding to the UUID.

15. The method according to claim 1, wherein executing the control operation corresponding to the audio control information comprises:
decoding the audio control information using an encoding format of a Low Energy Bluetooth Audio Mandatory Codec, and executing the control operation represented by a decoded audio data.

16. The method according to claim 1, wherein the peer device comprises a headset, and establishing the GATT connection with the peer device and, based on the GATT connection, establishing the audio transmission link with the peer device comprises:
establishing the GATT connection with the headset, and based on the GATT connection, respectively establishing audio transmission links with a left earbud and a right earbud of the headset; and
wherein the audio transmission links of the left earbud and right earbud form a connection synchronization group.

17. The method according to claim 16, wherein receiving the audio control information transmitted by the peer device through the audio transmission link based on the voice service comprises:
receiving the audio control information transmitted by the headset through the audio transmission links of the connection synchronization group based on the voice service.

18. A device control apparatus, applied to a current device, comprising:
an attribute service connection module configured to establish a Generic Attribute Profile (GATT) connection with a peer device and, based on the GATT connection, establish an audio transmission link with the peer device;
a voice service connection module configured to acquire a voice service identifier broadcasted by the peer device and establish, via the GATT connection, a connection to a voice service corresponding to the voice service identifier;
an audio transmission module configured to receive, based on the voice service, an audio control information transmitted by the peer device through the audio transmission link; and
an operation execution module configured to execute a control operation corresponding to the audio control information.

19. An electronic device, comprising a memory, a processor, and a computer program stored on the memory and executable by the processor, wherein the processor, when executing the computer program, performs
establishing a Generic Attribute Profile (GATT) connection with a peer device, and based on the GATT connection, establishing an audio transmission link with the peer device;
acquiring a voice service identifier broadcasted by the peer device, and establishing, via the GATT connection, a connection to a voice service corresponding to the voice service identifier:
receiving, based on the voice service, an audio control information transmitted by the peer device through the audio transmission link; and
executing a control operation corresponding to the audio control information.

20. (canceled)

21. The electronic device according to claim 19, wherein the peer device comprises at least two devices, and the processor is configured to establish, via the GATT connection established with each of peer devices, a respective connection to the voice service corresponding to the voice service identifier broadcasted by each of the peer devices.
